(19) United States
(12) Patent Application Publication
(10) Pub. No.: US 2003/0173509 A1
(43) Pub. Date: Sep. 18, 2003

(54) Optical scanning stage

(75) Inventors: Tadashi Ito, Sagamihara-shi (JP); Isao Nakazawa, Otsuki-shi (JP); Shigeru Komiyama, Fussa-shi (JP)

Correspondence Address: Scully, Scott, Murphy & Presser, 400 Garden City Plaza, Garden City, NY, 11530-0299, US

(73) Assignee: OLYMPUS OPTICAL CO., LTD., TOKYO (JP)

(21) Appl. No.: 10/387,316

(22) Filed: Mar. 12, 2003

(30) Foreign Application Priority Data
Mar. 14, 2002 (JP) 2002-070532

(51) Int. Cl. H01J 3/14

(52) U.S. Cl. 250/235

(57) ABSTRACT

The present invention is directed to an optical scanning stage. The optical scanning stage comprises a specimen holder that holds the specimen, a main scanning guide that guides the specimen holder along a main scanning axis, a sub-scanning stage that supports the specimen holder through the main scanning guide, and a main scanning driving mechanism that scans the specimen along the main scanning axis. The main scanning driving mechanism comprises a motor having a rotation shaft that rotates in one direction, and a movement conversion mechanism that converts a one-directional rotary motion of the rotation shaft of the motor to a linear reciprocation.

### CROSS-REFERENCE TO RELATED APPLICATIONS

This application is based upon and claims the benefit of priority from the prior Japanese Patent Application No. 2002-070532, filed Mar. 14, 2002, the entire contents of which are incorporated herein by reference.

### BACKGROUND OF THE INVENTION

1. Field of the Invention

The present invention relates to an optical scanning stage, which scans a specimen with respect to an optical system.

2. Description of the Related Art

U.S. Pat. No. 5,895,915 discloses a scanning system including spring-reinforced tense belts, which converts a rotary motion of a servo-controlled actuator to a translational movement of a sample (along a scanning line, that is, high-speed scanning direction) with respect to a fixed objective lens. A first tense steel belt is attached to a first end of a shuttle for moving the sample in the high-speed scanning direction. This belt is partially wound around a lightweight wheel in one direction, which is rotated by the servo-controlled actuator (movable magnet rotation galvanometer). A second end of the belt is attached to a spring to which a load is applied beforehand, and the spring is attached to the wheel. A second tense steel belt is partially wound around the wheel in a reverse direction, one end of the belt is attached to the wheel, and the other end is attached to a second end of the shuttle. The shuttle moves forwards with the rotation of the wheel in one direction, and moves backwards with the rotation of the wheel in the other direction.

In the scanning system of the U.S. Pat. No. 5,895,915, a spring property is imparted to the belt in order to extend the belt around the wheel, and the belt pulls the shuttle and sample in a structure.

Since the spring property needs to be imparted to the belt, mechanical rigidity of the belt is necessarily low.

### BRIEF SUMMARY OF THE INVENTION

According to the present invention, there is provided an optical scanning stage comprising: a specimen holder that holds the specimen; a main scanning guide that guides the specimen holder along a main scanning axis; a sub-scanning stage that supports the specimen holder through the main scanning guide; and a main scanning driving mechanism that scans the specimen holder along the main scanning axis. The main scanning driving mechanism includes: a motor that includes a rotation shaft rotated in one direction; and a movement conversion mechanism that converts a rotary motion of the rotation shaft of the motor in one direction to a linear reciprocation. A preferable movement conversion mechanism is constructed from members that are made from materials having high mechanical rigidity, and that have shapes having high mechanical rigidity. In one example, the movement conversion mechanism is constituted of a crank connected to the rotation shaft of the motor, and a connecting rod connected to the specimen holder, and the connecting rod is connected so as to be rotatable with respect to the crank and specimen holder. In another example, the movement conversion mechanism is constituted of a pulley connected to the rotation shaft of the motor and a cam pin guide connected to the specimen holder, the pulley includes a cam groove, and the cam pin guide includes a cam pin contained in the cam groove of the pulley.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 shows a constitution of an optical scanning stage according to an embodiment of the present invention;

FIG. 2 shows a two-dimensional pattern of scanning performed by the optical scanning stage of FIG. 1;

FIG. 3 shows another two-dimensional pattern of scanning performed by the optical scanning stage of FIG. 1;

FIG. 4 shows a relation between a relative position of an optical axis and specimen holder, and a speed of the specimen holder;

FIG. 5 shows an improved movement conversion mechanism for converting a one-directional rotary motion of a rotation shaft of a motor to a linear reciprocation;

FIG. 6 shows another counterbalance fixed to a crank in a position different from that of FIG. 5; and

FIG. 7 shows another movement conversion mechanism comprising a cam mechanism, which may substitute for the movement conversion mechanism comprising the crank and connecting rod shown in FIG. 1.

### DETAILED DESCRIPTION OF THE INVENTION

An embodiment of the present invention will be described hereinafter with reference to the drawings.

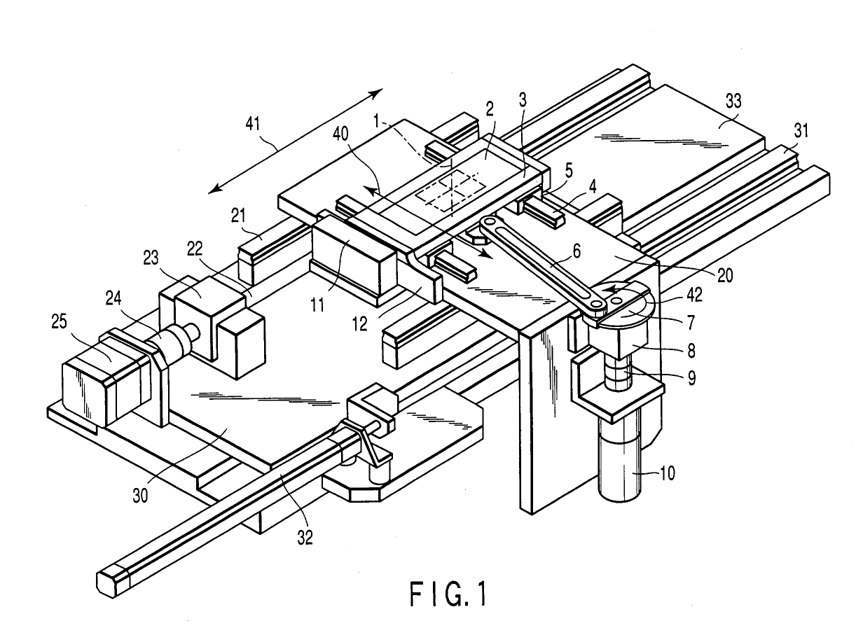

A constitution of an optical scanning stage of the present embodiment is shown in FIG. 1.

As shown in FIG. 1, the optical scanning stage includes a specimen holder 3 as a main scanning stage for holding a specimen 2, a pair of main scanning linear guides for guiding the specimen holder 3 along a main scanning axis 40, a sub-scanning stage 20 supporting the specimen holder 3 through the main scanning linear guides, and a main scanning driving mechanism for scanning the specimen holder 3 along the main scanning axis 40.

Each main scanning linear guide includes a rail 4 linearly extending along the main scanning axis 40, and a carriage 5 allowed to displace on the rail. The rail 4 is fixed to the sub-scanning stage 20, and the carriage 5 is fixed to the specimen holder 3. Accordingly, the specimen holder 3 is allowed to relatively reciprocate, i.e., displace alternately backward and forward along the main scanning axis 40 with respect to the sub-scanning stage 20.

The main scanning driving mechanism comprises a motor 10 having a rotation shaft, which rotates in one direction, a movement conversion mechanism, which converts a rotary motion of the rotation shaft of the motor 10 to a linear reciprocation, and a coupling 9 connecting the movement conversion mechanism to the motor 10.

The movement conversion mechanism is constructed from members that are made from materials having high mechanical rigidity, and that have shapes having high mechanical rigidity, i.e., shapes that are hardly deformed during operation. The movement conversion mechanism comprises, for example, a disc-shaped crank 7 and bar-shaped connecting rod 6. The crank 7 and connecting rod 6 are formed of materials having high mechanical rigidity. The crank 7, which is rotatably supported by a bearing holder 8, and connected to the rotation shaft of the motor 10 through a coupling 9, is allowed to rotate in one direction, as shown by an arrow 42, in accordance with the one-directional rotation of the rotation shaft of the motor 10. The connecting rod 6 substantially has a linearly extending rod shape having two ends. One end of the connecting rod 6 is rotatably pivoted to the crank 7, and the other end is rotatably pivoted to the specimen holder 3.

Accordingly, the specimen holder 3 reciprocates, i.e., displaces alternately backward and forward along the main scanning axis 40 with respect to the sub-scanning stage 20 in accordance with the one-directional rotation of the rotation shaft of the motor 10.

The optical scanning stage further includes a main scanning position read system for measuring an amount of displacement of the specimen holder 3 along the main scanning axis 40. The main scanning position read system comprises a linear scale, for example. The linear scale includes a scale 12 and read portion 11. The scale 12 is fixed to the specimen holder 3, and the read portion 11 is fixed to the sub-scanning stage 20. The scale 12 relatively displaces along the main scanning axis 40 with respect to the read portion 11 in accordance with the displacement of the specimen holder 3 with respect to the sub-scanning stage 20.

The scale 12 includes an optical pattern having a periodic structure that has an optical characteristic (e.g., reflectance) changing along the main scanning axis 40 at a constant pitch. The read portion 11 includes a light source for illuminating the optical pattern of the scale 12, and a detector for detecting a reflected light from the optical pattern of the scale 12. The detector, which has a light receiving region, outputs an electric signal corresponding to intensity of light received by the light receiving region.

A magnitude of the electric signal outputted from the detector changes in response to the displacement of the scale 12 with respect to the read portion 11. For example, when the scale 12 displaces at a constant speed, the electric signal substantially having a sine waveform changing at a constant period is outputted from the detector of the read portion 11. The period of the electric signal of the substantial sine waveform corresponds to a pitch of a period structure of the optical pattern of the scale 12. Therefore, the amount of displacement of the scale 12 with respect to the read portion 11 can be obtained by analyzing the electric signal outputted from the detector of the read portion 11, for example, by counting the number of peaks of the electric signal.

The optical scanning stage further includes a pair of sub-scanning linear guides for guiding the sub-scanning stage 20 along a sub-scanning axis 41, a loading stage 30 supporting the sub-scanning stage 20 through the sub-scanning linear guides, and a sub-scanning driving mechanism for scanning the sub-scanning stage 20 along the sub-scanning axis 41.

Each of the sub-scanning linear guides includes a rail 21 linearly extending along the sub-scanning axis 41, and a carriage (not shown) allowed to displace on the rail 21. The rail 21 is fixed to the loading stage 30, and the carriage is fixed to the sub-scanning stage 20. Accordingly, the sub-scanning stage 20 is allowed to relatively reciprocate with respect to the loading stage 30 along the sub-scanning axis 41.

The sub-scanning driving mechanism comprises a stepping motor 25, ball screw, and coupling 24. The stepping motor 25, which is fixed to the loading stage 30, includes a rotation shaft allowed to rotate clockwise and counterclockwise.

The ball screw includes a screw shaft 22, and a ball screw nut (not shown) allowed to displace on the screw shaft. The ball screw nut, which includes a plurality of ball members, is connected to the screw shaft 22 through the ball members. The screw shaft 22 is rotatably supported by a bearing holder 23 fixed to the loading stage 30.

The coupling 24 connects the rotation shaft of the sub-scanning stepping motor 25 to the screw shaft 22 of the ball screw. Therefore, the screw shaft 22 rotates clockwise and counterclockwise in accordance with the clockwise and counterclockwise rotation of the rotation shaft of the sub-scanning stepping motor 25.

A ball screw nut displaces on the screw shaft 22 in accordance with the rotation of the screw shaft 22. That is, the ball screw converts the rotary motion of the screw shaft 22 to the linear movement of the ball screw nut. Thereby, the sub-scanning stage 20 reciprocates, i.e., displaces alternately backward and forward along the sub-scanning axis 41 with respect to the loading stage 30, in response to the clockwise and counterclockwise rotation of the rotation shaft of the stepping motor 25.

The stepping motor 25 is controlled by a stepping motor control circuit (not shown). A rotation angle of the rotation shaft of the stepping motor 25 is obtained by counting control pulses of the stepping motor control circuit. Moreover, the amount of displacement of the sub-scanning stage 20 along the sub-scanning axis 41 is calculated from a screw pitch and rotation angle of the screw shaft 22. Therefore, the amount of displacement of the sub-scanning stage 20 can be obtained by counting the control pulses of the stepping motor control circuit. In other words, it could also be said that the stepping motor control circuit constitutes a sub-scanning position read system for measuring the amount of displacement of the sub-scanning stage 20 along the sub-scanning axis 41.

The optical scanning stage further includes a pair of loading linear guides for guiding the loading stage 30 along one axis, a base 33 supporting the loading stage 30 through the linear guides for loading, and a loading driving mechanism for displacing the loading stage 30.

Each of the linear guides for loading includes a rail 31 linearly extending along the sub-scanning axis 41, and a carriage (not shown) allowed to displace on the rail. The rail 31 is fixed to a base 33, and the carriage is fixed to the loading stage 30. Accordingly, the loading stage 30 is allowed to relatively reciprocate along the sub-scanning axis 41 with respect to the base 33.

The loading driving mechanism comprises, for example, an air cylinder 32 including a piston allowed to move backward and forward. The air cylinder 32 is fixed to the base 33. An end of the piston is connected to the loading stage 30. Therefore, the loading stage 30 reciprocates in accordance with the back-and-forth movement of the piston of the air cylinder 32.

The optical scanning stage is combined with a fluorescent microscope, for example. The back-and-forth movement of the piston of the air cylinder 32 causes the loading stage 30 to reciprocate along the sub-scanning axis 41. Thereby, the specimen holder 3 is moved between an observation position by the fluorescent microscope (e.g., a position on a left front side in FIG. 1) and an attachment/detachment position of the specimen 2 (e.g., a position on a right inner side in FIG. 1).

For attachment/detachment of the specimen 2, the specimen holder 3 is disposed in the attachment/detachment position. The specimen holder 3 includes a mount surface on which the specimen 2 is mounted, and the specimen 2 is mounted on the mount surface. As not shown, the specimen holder 3 has holes formed in the mount surface, which are connected to a suction pump. After mounting, the specimen 2 is firmly fixed to the specimen holder 3 by air adsorption, that is, by evacuating the inside of the holes of the specimen holder 3 at a negative pressure with the suction pump. After attaching the specimen 2, the specimen holder 3 is transported or loaded into an observation position by the fluorescent microscope.

The specimen 2 comprises a slide glass with materials, such as a sample labeled with a fluorescent dyestuff, disposed on it. As not shown, the fluorescent microscope includes, for example, an excitation optical system for illuminating the specimen 2 with excitation light, an image forming optical system for imaging fluorescence generated from the specimen 2, and a photoelectric conversion device for photoelectrically converting the fluorescence. The fluorescent microscope illuminates the specimen 2 with the excitation light such as laser light, which excites the fluorescent dyestuff to cause it to generate the fluorescence, and detects the fluorescence on the optical axis 1 with the photoelectric conversion device such as a photo multiplier through the image forming system.

During observation by the fluorescent microscope, the specimen 2 is two-dimensionally scanned. That is, the specimen 2 is main-scanned while sub-scanned. That is, the specimen 2 is reciprocated along the main scanning axis 40, while reciprocated along the sub-scanning axis 41.

The main scanning of the specimen 2 is performed by the motor 10. The one-directional rotation of the rotation shaft of the motor 10, as shown by the arrow 42, causes the crank 7 to be rotated in one direction. The one-directional rotation of the crank 7 causes the connecting rod 6 to be reciprocated along the main scanning axis 40 with change of the direction. The reciprocation of the connecting rod 6 causes the specimen holder 3 to be linearly reciprocated along the main scanning axis 40. As a result, the specimen 2 is linearly reciprocated or main-scanned along the main scanning axis 40 with respect to the optical axis 1 of the fluorescent microscope. The amount of displacement of the specimen 2 along the main scanning axis 40 is obtained by the linear scale comprising the scale 12 and read portion 11.

The scanning of the specimen 2 is performed by the stepping motor 25. The rotation of the rotation shaft of the stepping motor 25 causes the screw shaft 22 to rotate. The rotation of the screw shaft 22 causes the sub-scanning stage 20 to linearly displace along the sub-scanning axis 41 by the ball screw nut. As a result, the specimen 2 is linearly displaced along the sub-scanning axis 41, that is, sub-scanned with respect to the optical axis 1 of the fluorescent microscope. The amount of displacement of the specimen 2 along the sub-scanning axis 41 is obtained based on the control pulses of the stepping motor control circuit.

The specimen 2 is two-dimensionally scanned in combination with the main scanning and the sub-scanning. Moreover, the specimen 2 is scanned with various two-dimensional scanning patterns by changing a manner of control of the main scanning and sub-scanning.

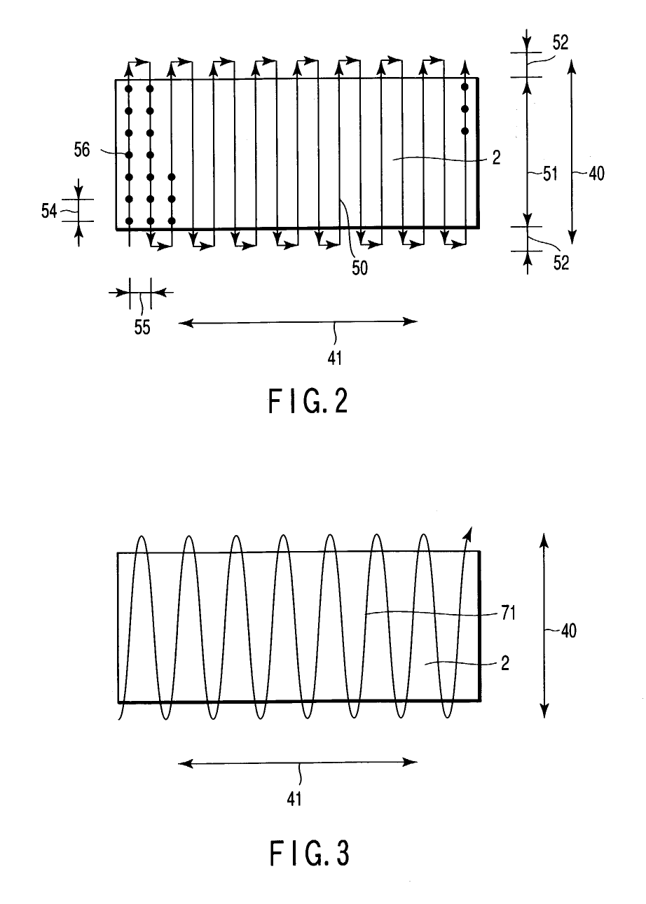

A two-dimensional scanning pattern, that is, a combined pattern of the main scanning and sub-scanning is shown in FIG. 2. A shown arrow 50 indicates a track of relative displacement of the specimen 2 and optical axis 1.

In the two-dimensional scanning pattern, the motor 10 is continuously driven at a constant speed so that the specimen 2 is continuously linearly reciprocated along the main scanning axis 40, and the stepping motor 25 is intermittently pulse-driven as the specimen 2 is positioned in a non-observation range 52 outside an observation range 51 so that the specimen 2 is displaced along the sub-scanning axis 41. Thereby, the optical axis 1 relatively moves along the track shown by the arrow 50 with respect to the specimen 2. It is detected by the linear scale comprising the scale 12 and read portion 11 whether the specimen 2 is positioned in the observation range 51 or in the non-observation range 52.

An observation resolution is designated beforehand during the scanning. A displacement width 55 along the sub-scanning axis 41 corresponds to the designated observation resolution. While the specimen 2 is positioned in the observation range 51, the amount of displacement along the main scanning axis 40 of the specimen 2 is detected with the linear scale, with the output of the photo multiplier being sampled at a timing corresponding to an interval 54 corresponding to the designated observation resolution. By the control, the fluorescence in each position 56 in the observation range of the specimen 2 is measured with the designated observation resolution.

The sampling positions 56 on the specimen 2 are aligned with constant intervals, so that the observation range 51 is uniformly scanned. Therefore, the scanning in accordance with the two-dimensional scanning pattern is suitable for good-precision uniform scanning of the specimen.

Another two-dimensional scanning pattern, that is, another combined pattern of the main scanning and sub-scanning is shown in FIG. 3.

In the two-dimensional scanning pattern, the motor 10 is continuously driven at a constant speed so that the specimen 2 is continuously linearly reciprocated along the main scanning axis 40, and the stepping motor 25 is continuously driven at the constant speed so that the specimen 2 is displaced along the sub-scanning axis 41 at the constant speed. Thereby, the optical axis 1 relatively moves along the track shown by an arrow 71 with respect to the specimen 2.

Even in this two-dimensional scanning pattern, while the specimen 2 is positioned in the observation range, the amount of displacement of the specimen 2 along the main scanning axis 40 is detected with the linear scale, with the output of the photo multiplier being sampled at the timing corresponding to the interval corresponding to the designated observation resolution. By this control, the fluorescence in each position in the observation range of the specimen 2 is measured with the designated observation resolution.

In the scanning along the two-dimensional scanning pattern of FIG. 2, a phase delay of displacement or limit response frequency exists depending on inertia moment of members displaced along the sub-scanning axis 41. A time lag is generated from when a driving command is given to the stepping motor 25 until the driving is completed. Therefore, in the scanning at the very high speed, a situation occurs in which the displacement along the sub-scanning axis 41 is not completed in the non-observation range 52.

In the scanning along the two-dimensional scanning pattern of FIG. 3, since the stepping motor 25 is continuously driven at the constant speed, the member displaced along the sub-scanning axis 41 is not accelerated in a short time, such that an influence of phase delay or limit response frequency is not exerted. Accordingly, the scanning along the two-dimensional scanning pattern of FIG. 3 is suitable for the scanning at a very high speed or particularly the scanning of a heavy specimen.

In the optical scanning stage of the present embodiment, the one-directional rotary motion of the rotation shaft of the motor 10 is converted into a linear reciprocation of the specimen holder 3 with the movement conversion mechanism including the crank mechanism comprising the crank 7 and connecting rod 6. The disc-shaped crank 7 and bar-shaped connecting rod 6 constituting the crank mechanism both are made from materials having high mechanical rigidity, and have shapes that are hardly deformed during operation. Therefore, the movement conversion mechanism for converting the rotary motion to the linear reciprocation has high mechanical rigidity. The movement conversion mechanism having the high mechanical rigidity can bear a relatively large impact and load. That is, the optical scanning stage of the present embodiment, which has the high mechanical rigidity so as to be allowed to bear the relatively large impact or load, is suitable for the scanning at a higher speed or the scanning of a heavier specimen.

Moreover, the optical scanning stage of the present embodiment does not include a member having a spring property, and therefore a problem of a spring coefficient change with time does not occur. Since the specimen 2 is continuously linearly reciprocated by continuous one-directional rotation of the rotation shaft of the motor 10, the control is easy. Moreover, since the continuous linear reciprocation is realized with a simple constitution including a conventional rotary motor and crank mechanism, the optical scanning stage of the present embodiment is advantageous in assembly property and cost.

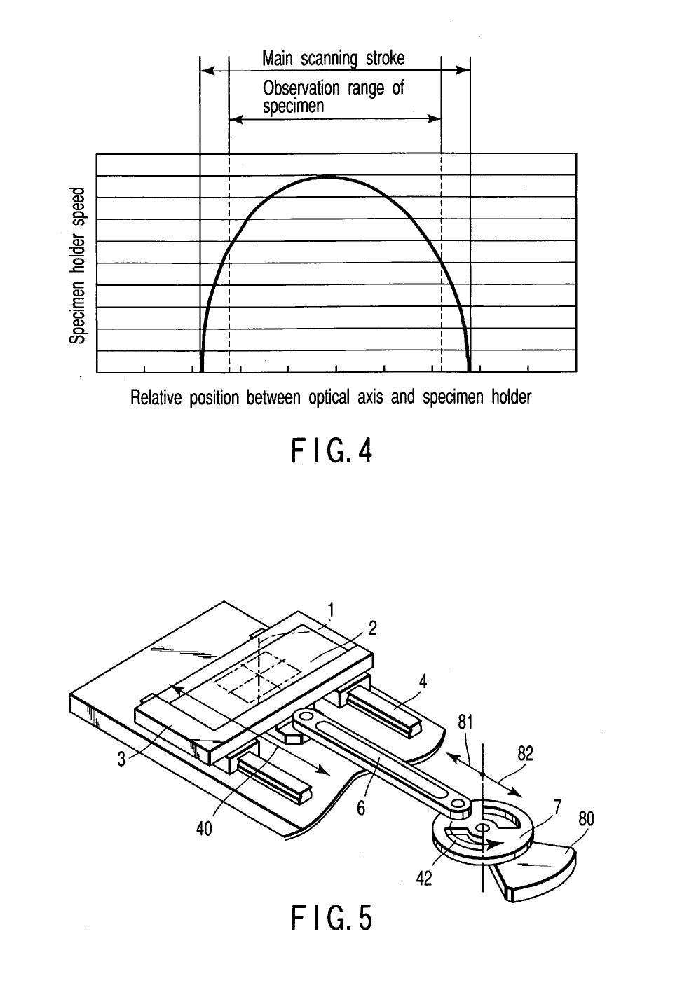

Further, since a track of a connection portion of the crank 7 and connecting rod 6 is close to a perfect circle, as shown in FIG. 4, the specimen holder 3 is displaced with a relatively moderate acceleration/deceleration. Therefore, impact or load of the continuous linear reciprocation at a direction change time is relatively small. For this reason, the optical scanning stage of the present embodiment is suitable for the scanning at the high speed or the scanning of the heavy specimen.

In the optical scanning stage of the present embodiment, a change is generated in the scanning speed of the specimen holder 3 in the observation range, but a time resolution of the output of the photo multiplier is designed to be sufficiently high with respect to the width of the change of the scanning speed of the specimen holder 3. Thereby, the influence of the scanning speed change onto the fluorescent observation result can sufficiently be reduced for practical use.

Moreover, for example, in a constitution for optically performing the scanning, such as a scanning type microscope with a galvanometer mirror, in order to obtain a long scanning stroke, an effective diameter of an optical system needs to be accordingly enlarged. Therefore, it is relatively difficult to obtain the long stroke.

On the other hand, in the optical scanning stage of the present embodiment, the stroke along the main scanning axis 40 can be easily lengthened only by increasing a rotation radius of the crank 7, and lengthening the rail 4 of the main scanning linear guide. Therefore, the optical scanning stage of the present embodiment is also preferable for the scanning of the long stroke.

In the optical scanning stage of the present embodiment, the specimen 2 is held by the specimen holder 3 by air adsorption. In the air adsorption, since an adsorption force is easily operated, the specimen 2 is held with an appropriate adsorption force. Thereby, the specimen 2 is held with a small strain. When a large strain is generated in the specimen 2 along the optical axis 1, a surface of the specimen deviates from a focal point depth of an image forming optical system by the strain during the scanning, and a problem occurs that the output of the photo multiplier changes. However, in the optical scanning stage of the present embodiment, since the specimen 2 is held with the specimen holder 3 by the air adsorption with the small strain, the stage is preferable for good-precision scanning in a broad observation range.

In the optical scanning stage of the present embodiment, the amount of displacement of the specimen 2 along the main scanning axis 40 is obtained by the linear scale. In the constitution for measuring the amount of displacement of the specimen 2 along the main scanning axis 40 based on an encoder for detecting the angle of the rotation shaft of the motor 10, a measurement error is generated by backlash of the rotation shaft of the motor. In the optical scanning stage of the present embodiment, since the amount of displacement along the main scanning axis 40 of the specimen 2 is obtained by the linear scale, there is few measurement error caused by the backlash of the rotation shaft of the motor, and the stage is suitable for the good-precision scanning.

In the optical scanning stage of the present embodiment, the amount of displacement along the sub-scanning axis 41 of the specimen 2 is obtained by counting the control pulses of the stepping motor control circuit. That is, the measurement of the amount of displacement of the specimen 2 along the sub-scanning axis 41 is realized by a simple constitution with good precision, without using any special displacement measurement system. Therefore, the optical scanning stage of the present embodiment is advantageous in assembly property, controllability, and cost.

The optical scanning stage of the present embodiment has a loading function. Thereby, the specimen 2 is attached to or detached from the specimen holder 3 in a position apart from the observation position. Therefore, the specimen 2 is easily attached/detached with respect to the specimen holder 3.

The loading function may be realized by lengthening the rail 21 of the sub-scanning linear guide and the screw shaft 22 of the ball screw. This constitution is advantageous in the assembly property, controllability, and cost.

However, in the optical scanning stage of the present embodiment, separately from the sub-scanning linear guides and sub-scanning driving mechanism, the linear guides for loading and air cylinder 32 are disposed. Therefore, inertia mass of the member displaced along the sub-scanning axis 41 is small. Therefore, the optical scanning stage of the present embodiment is suitable for the scanning at the high speed or the scanning of the heavy specimen.

The embodiment of the present invention has been described above with reference to the drawings, but the present invention is not limited to these embodiments, and may be modified or changed in a range without departing from the scope.

The optical scanning stage may be used not only for fluorescent observation but also for various types of observation such as transmitted light observation, reflected light observation, and scattered light observation. A photoelectric conversion device is not limited to the photo multiplier, and various photoelectric conversion devices such as a CCD or CMOS sensor and photodiode may also be used. The fluorescent may visually be observed without using the photoelectric conversion device.

The fixing of the specimen 2 onto the specimen holder 3 is not limited to air absorption. As long as flatness of the specimen 2 is appropriate, the specimen 2 may also be fixed to the specimen holder 3 with springs or screws.

The driving of the motor 10 is not limited to the continuous rotating of the rotation shaft in one direction. Depending on scanning conditions, the motor 10 may intermittently be driven so that the rotation shaft repeats rotation and stop, or may also be driven so that the rotation shaft repeats forward and backward rotations. Moreover, the rotation speed control of the motor 10 may be constant-speed control, control for repeating acceleration/deceleration, or constant-voltage control. Naturally, by the rotation speed control of the motor 10, the specimen holder 3 may also be controlled so as to perform a uniform-speed movement in the observation range.

The main scanning linear guide may also be various linear driving mechanisms such as a shaft and ball bush, and a shaft and round hole. Moreover, the members such as the specimen holder 3, connecting rod 6, and crank 7 may also be reduced in weight by thinning the materials.

In the embodiment, the problem of the deviation of the specimen surface from the focal point depth of the image forming optical system during the scanning is reduced by holding low strain by air adsorption. However, this problem may also be reduced in a real time auto focus. In this case, an end-measuring unit for detecting a position along the optical axis in each position of the specimen surface, and a driving mechanism for displacing the specimen surface or image forming optical system along the optical axis are further disposed. An operation for displacing the specimen surface along the optical axis based on a measured value and focusing the surface is performed during the scanning. Moreover, the above-described end measuring unit is used to measure a strain amount in each position in the observation range. Then, for a position in which strain amount from the focused position is minimum, an average value of strain amounts of the respective positions is subjected to focus adjustment, so that the influence of the strain may be reduced.

An improved movement conversion mechanism for converting the one-directional rotary motion of the rotation shaft of the motor 10 to the linear reciprocation is shown in FIG. 5. In addition to the crank 7 and connecting rod 6, the movement conversion mechanism further includes a counterbalance 80 attached to the crank 7.

When the crank 7 rotates and the specimen holder 3 changes the direction in the shown position, a direction of the displacement changes, so that the specimen 2 or specimen holder 3 or both generate an impact load in a direction shown by an arrow 81. There is a possibility that the impact load becomes a cause for hindering the smooth linear reciprocation of the specimen holder 3 or a cause for generating vibration or noise.

Since the improved movement conversion mechanism includes the counterbalance 80, the counterbalance 80 generates the impact load in a direction shown by an arrow 82. Since the direction of the impact load generated by the counterbalance 80 is opposite to that of the impact load generated by the specimen 2 or specimen holder 3 or both, the impact loads generated by the counterbalance 80 and by specimen 2 and specimen holder 3 cancel each other. Thereby, the impact load generated at the direction change time of the specimen holder 3 is reduced.

As a result, the improved movement conversion mechanism generates little vibration or noise, causing the specimen holder 3 to smoothly linearly reciprocate along the main scanning axis 40. The improved movement conversion mechanism is suitable for the scanning at the high speed or the scanning of the heavy specimen.

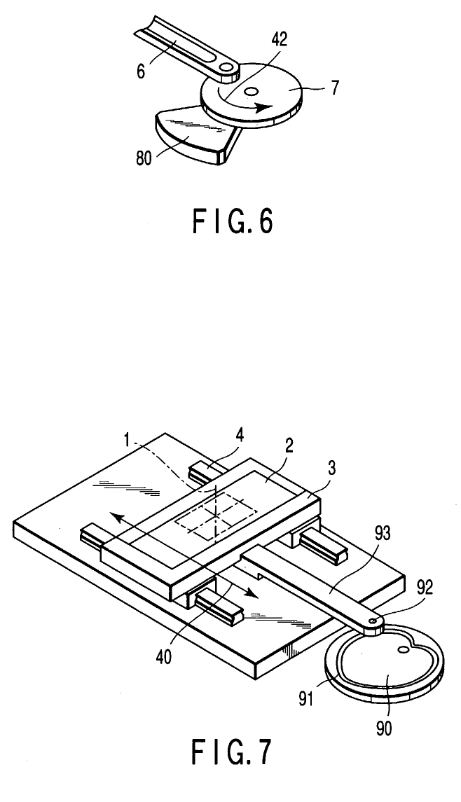

A fixed position of the counterbalance 80 onto the crank 7 is not limited to a position opposite to the connection portion of the connecting rod 6 and crank 7 with respect to a rotation center of the crank 7 as shown in FIG. 5. As shown in FIG. 6, the counterbalance 80 may also be fixed to a position off the opposite position of the connection portion of the connecting rod 6 and crank 7 with respect to the rotation center of the crank 7. The counterbalance 80 may be fixed to the crank 7 at any position off the connection portion of the connecting rod 6 and crank 7. It is to be noted that the crank 7 and counterbalance 80 may integrally be constituted.

Moreover, the counterbalance 80 is not limited to the shape shown in FIG. 5 or 6, and may also be formed in any shape, as long as the impact load generated at the direction change time of the specimen holder 3 is reduced.

In the embodiment, the movement conversion mechanism for converting the rotary motion to the linear reciprocation comprises the crank mechanism including the crank 7 and connecting rod 6, but this is not limited. For example, the mechanism may also comprise a cam mechanism in use of a cam groove and a cam pin. One example is shown in FIG. 7.

As shown in FIG. 7, the movement conversion mechanism comprising the cam mechanism includes a pulley 90 fixed to the rotation shaft of the motor 10, and a cam pin holder 93 fixed to the specimen holder 3. The pulley 90 includes a cam groove 91, the cam pin holder 93 includes a cam pin 92, which is contained in the cam groove 91.

The one-directional rotation of the motor 10 causes the pulley 90 to rotate in one direction. In accordance with the rotation of the pulley 90, the cam pin 92 moves along the cam groove 91. The displacement of the cam pin 92 causes the cam pin holder 93 to displace along the main scanning axis 40. As a result, the specimen holder 3 is linearly reciprocated along the main scanning axis 40.

Even in this constitution, both the pulley 90 and cam pin holder 93 are formed of the materials having high mechanical rigidity, and the shapes are not deformed. Therefore, the movement conversion mechanism comprising the cam mechanism has high mechanical rigidity. Therefore, the optical scanning stage including the movement conversion mechanism comprising the cam mechanism also has high mechanical rigidity to bear a relatively large impact or load, and is therefore suitable for the scanning at the high speed and the scanning of the heavy specimen.

The cam pin 92 may directly be disposed in the specimen holder 3. In this case, the cam pin holder 93 is omitted. The cam groove 91 is not limited to the shape shown in FIG. 7, and may be changed to various shapes in accordance with a desired operation of the specimen holder 3.

Moreover, in FIG. 1, the scale 12 of the linear scale is fixed to the sub-scanning stage 20, and the read portion 11 of the linear scale may also be fixed to the specimen holder 3.

A position read system is not limited to the linear scale. The position read system may also comprise an optical displacement measurement system represented by heterodyne measurement and including a mirror and measurement light, a contact type displacement measurement system represented by a dial gauge, or a magnetic displacement measurement system.

A sub-scanning position read system for measuring the displacement of the sub-scanning stage 20 along the sub-scanning axis 41 may also be constituted of an optical displacement measurement system represented by heterodyne measurement and including the mirror and measurement light, the contact type displacement measurement system represented by the dial gauge, or the magnetic displacement measurement system.

The sub-scanning linear guide may also be various linear driving mechanisms such as the shaft and ball bush, and the shaft and round hole. The screw shaft 22 of the ball screw may also be a trapezoidal screw or feed screw. The stepping motor 25 may also be a servo motor.

Naturally, different values may also be set to observation resolutions along the main scanning axis 40 and sub-scanning axis 41.

The linear loading guide may also be various linear driving mechanisms such as the shaft and ball bush, and the shaft and round hole.

The air cylinder 32 may also be constituted of various motors such as a stepping motor and DC motor, and various feed mechanisms such as a rack and pinion, ball screw, trapezoidal screw, and feed screw.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

What is claimed is:

1. An optical scanning stage comprising:
a specimen holder that holds the specimen;
a main scanning guide that guides the specimen holder along a main scanning axis;
a sub-scanning stage supporting the specimen holder through the main scanning guide; and
a main scanning driving mechanism that scans the specimen holder along the main scanning axis, the main scanning driving mechanism comprising a motor having a rotation shaft that rotates in one direction, and a movement conversion mechanism that converts a one-directional rotary motion of the rotation shaft of the motor to a linear reciprocation.

2. The optical scanning stage according to claim 1, wherein the movement conversion mechanism is constructed from members that are made from materials having high mechanical rigidity, and that have shapes having high mechanical rigidity.

3. The optical scanning stage according to claim 2, wherein the movement conversion mechanism comprises a crank connected to the rotation shaft of the motor, and a connecting rod connected to the specimen holder, the connecting rod being rotatably connected to the crank and the specimen holder.

4. The optical scanning stage according to claim 3, wherein the movement conversion mechanism further comprises a counterbalance fixed to the crank, the counterbalance being off a connection portion of the crank and connecting rod.

5. The optical scanning stage according to claim 2, wherein the movement conversion mechanism comprises a pulley connected to the rotation shaft of the motor, and a cam pin guide connected to the specimen holder, the pulley including a cam groove, and the cam pin guide including a cam pin received in the cam groove of the pulley.

6. The optical scanning stage according to claim 1, further comprising a sub-scanning guide that guides the sub-scanning stage along a sub-scanning axis, a loading stage supporting the sub-scanning stage through the sub-scanning guide, and a sub-scanning driving mechanism that scans the sub-scanning stage along the sub-scanning axis.

7. The optical scanning stage according to claim 6, wherein the sub-scanning driving mechanism intermittently displaces the sub-scanning stage along the sub-scanning axis.

8. The optical scanning stage according to claim 6, wherein the sub-scanning driving mechanism displaces the sub-scanning stage along the sub-scanning axis at a constant speed.

9. The optical scanning stage according to claim 1, further comprising a loading guide that guides a loading stage along an axis, a base supporting the loading stage through the loading guide, and a loading driving mechanism that displaces the loading stage.

10. The optical scanning stage according to claim 1, further comprising a mechanism that fixes the specimen onto the specimen holder by air adsorption.
